(19) United States
(12) Patent Application Publication
(10) Pub. No.: US 2025/0304465 A1
(43) Pub. Date: Oct. 2, 2025

(54) NICKEL-CONTAINING HYDROXIDE AND POSITIVE ELECTRODE ACTIVE MATERIAL WITH NICKEL-CONTAINING HYDROXIDE AS PRECURSOR

(71) Applicant: TANAKA CHEMICAL CORPORATION, Fukui (JP)

(72) Inventors: Daiki KANEKO, Fukui (JP); Ryota KOBAYASHI, Fukui (JP)

(73) Assignee: TANAKA CHEMICAL CORPORATION, Fukui (JP)

(21) Appl. No.: 19/089,881

(22) Filed: Mar. 25, 2025

(30) Foreign Application Priority Data
Mar. 26, 2024 (JP) 2024-050493

(51) Int. Cl. C01G 53/84; H01M 4/02; H01M 4/525; H01M 10/0525

(52) U.S. Cl. CPC C01G 53/84; H01M 4/525; H01M 10/0525; C01P 2004/54; C01P 2004/61; C01P 2006/40; H01M 2004/028

(57) ABSTRACT

Provided is a nickel-containing hydroxide which is a precursor of a positive electrode active material for a non-aqueous electrolyte secondary battery, wherein in the frequency distribution in the aspect ratio measurement of secondary particles of the nickel-containing hydroxide, the maximum peak value of the frequency is 4.60% or more.

### CROSS REFERENCE TO RELATED APPLICATIONS

The present application claims the benefit of foreign priority to Japanese Patent Application No. 2024-050493, filed on Mar. 26, 2024, which is incorporated herein by reference in its entirety.

### BACKGROUND

### Technical Field

The present disclosure relates to a nickel-containing hydroxide and a positive electrode active material with the nickel-containing hydroxide as a precursor, and particularly to a nickel-containing hydroxide having an excellent yield and improved productivity and a positive electrode active material with the nickel-containing hydroxide as a precursor.

### Description of the Related Art

In recent years, from the point of view of reducing environmental load, secondary batteries have been used in a wide range of fields, such as portable devices and vehicles that use or combine electricity as a power source. Examples of the secondary batteries include secondary batteries that use non-aqueous electrolytes, such as lithium-ion secondary batteries. The secondary batteries that use non-aqueous electrolytes, such as lithium-ion secondary batteries, are suitable for miniaturization and weight reduction, and have excellent characteristics such as high output characteristics and battery capacity.

On the other hand, the devices and vehicles equipped with the non-aqueous electrolyte secondary batteries have been increasingly sophisticated, and as a result, further improvement in output characteristics and battery capacity has been required for the non-aqueous electrolyte secondary batteries. Accordingly, a nickel composite hydroxide has been proposed which is composed of plate-shaped secondary particles formed by agglomeration as a result that the plate surfaces of a plurality of plate-shaped primary particles overlap with each other, wherein the shape projected from a direction perpendicular to the plate surfaces of the plate-shaped primary particles is any of spherical, oblong or oval shape or the planar projection shape of a lump and wherein the aspect ratio of the secondary particles is 3 to 20; and which has a volume average particle size (Mv) of 4 μm to 20 μm as measured by laser diffraction scattering method (Japanese Patent Application Laid-Open No. 2016-011227).

Japanese Patent Application Laid-Open No. 2016-011227 describes that the shape of the positive electrode active material particles is plate-shaped and the plate-shaped particles are orientated during the production of an electrode to increase the surface area of the positive electrode active material particles compared to that of spherical particles having the same volume, thereby enabling high output characteristics and battery capacity, and the plate-shaped particles having a high aspect ratio are orientated, thereby enabling the thickness of the electrode to be reduced and the output to be further improved.

However, the nickel composite hydroxide of Japanese Patent Application Laid-Open No. 2016-011227, which is not composed of spherical particles but of plate-shaped secondary particles that are formed by agglomeration as a result that the plate surfaces of a plurality of plate-shaped primary particles overlap with each other, is reduced in the yield due to poor passage through a sieve of the nickel composite hydroxide obtained as a product, and it has left room for improvement in productivity.

The present disclosure is related to providing a nickel-containing hydroxide excellent in yield of the nickel-containing hydroxide obtained as a product, and a positive electrode active material with the nickel-containing hydroxide as a precursor.

### SUMMARY

The summary of aspects of the present disclosure is as follows.
[1] A nickel-containing hydroxide which is a precursor of a positive electrode active material for a non-aqueous electrolyte secondary battery, wherein in the frequency distribution in the aspect ratio measurement of secondary particles of the nickel-containing hydroxide, the maximum peak value of the frequency is 4.60% or more.
[2] The nickel-containing hydroxide according to [1], wherein the aspect ratio at the maximum peak value of the frequency is 0.85 or more.
[3] The nickel-containing hydroxide according to [1] or [2], wherein the aspect ratio at the maximum peak value of the frequency is 0.85 or more and 0.96 or less.
[4] The nickel-containing hydroxide according to any one of [1] to [3], represented by the following formula (A):

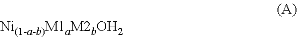

wherein 0<a≤0.8, 0≤b≤0.2, and 0<1−a−b; M1 is one or more additive elements selected from the group consisting of Co, Mn and Al; and M2 is one or more additive elements selected from the group consisting of Ca, Ti, V, Cr, Zr, Nb, Mo, B and W.
[5] The nickel-containing hydroxide according to any one of [1] to [4], wherein the particle size (D50) of the secondary particles of the nickel-containing hydroxide at a cumulative volume percentage of 50% by volume is 2.0 μm or more and 20.0 μm or less.
[6] The nickel-containing hydroxide according to any one of [1] to [5], wherein the non-aqueous electrolyte secondary battery is a lithium-ion secondary battery.
[7] A positive electrode active material for a non-aqueous electrolyte secondary battery, wherein the nickel-containing hydroxide according to any one of [1] to [6] is calcined with a lithium compound.

The term “the frequency distribution in the aspect ratio measurement” in the above aspect [1] means a graph showing the aspect ratio of secondary particles of a nickel-containing hydroxide on the abscissa axis (x-axis) and the frequency of the aspect ratio on the ordinate axis (y-axis). The term “aspect ratio” means the ratio between the short axis and the long axis of secondary particles of a nickel-containing hydroxide, that is, the short axis/the long axis, and the aspect ratio is in the range of more than 0.00 and 1.00 or less. The term “aspect ratio” also means the aspect ratio measured for each of 10,000 secondary particles of a nickel-containing hydroxide with an automated static image analyzer. The “frequency distribution in the aspect ratio measurement” is created from the aspect ratio of each of 10,000 secondary particles of a nickel-containing hydroxide. The “secondary particle” is an agglomerate of a plurality of primary particles.

The frequency (%) of the aspect ratio on the ordinate axis (y axis) is a value determined by measuring the aspect ratio of each of 10,000 secondary particles of a nickel-containing hydroxide, classifying the measured aspect ratio of each of the secondary particles at intervals of 0.01 in the range 0.00 to 1.00, and calculating [the number of particles with aspect ratio in the corresponding category/the total number of particles (10,000)]×100.

### Advantageous Effects of the Disclosure

According to an aspect of the present disclosure, in the frequency distribution in the aspect ratio measurement of secondary particles of a nickel-containing hydroxide, the maximum peak value of the frequency is 4.60% or more, so that the nickel-containing hydroxide excellent in yield as a product can be obtained. Therefore, according to the aspect of the present disclosure, the productivity of the nickel-containing hydroxide is improved.

According to another aspect of the present disclosure, the aspect ratio at the maximum peak value of the frequency is 0.85 or more, so that the nickel-containing hydroxide becomes more spherical and the nickel-containing hydroxide powder is further improved in average circularity, which leads to a further improvement in the yield of the nickel-containing hydroxide obtained as a product.

According to another aspect of the present disclosure, it is preferable that the nickel-containing hydroxide is represented by the following formula (A).

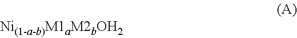

wherein 0<a≤0.8, 0≤b≤0.2, and 0<1−a−b; M1 is one or more additive elements selected from the group consisting of Co, Mn and Al; and M2 is one or more additive elements selected from the group consisting of Ca, Ti, V, Cr, Zr, Nb, Mo, B and W.

### BRIEF DESCRIPTION OF THE DRAWING

FIG. 1 is a graph showing the frequency distribution in the aspect ratio measurement for Example 1 and Comparative Example 3.

### DETAILED DESCRIPTION

Hereinafter, the nickel-containing hydroxide which is a precursor of the positive electrode active material for the non-aqueous electrolyte secondary battery of the present disclosure will be described in detail. The nickel-containing hydroxide which is a precursor of the positive electrode active material for the non-aqueous electrolyte secondary battery of the present disclosure (hereinafter, sometimes simply referred to as “nickel-containing hydroxide of the present disclosure”) is a secondary particle formed by agglomeration of a plurality of primary particles. The nickel-containing hydroxide of the present disclosure has a maximum peak value of the frequency of 4.60% or more in the frequency distribution in the aspect ratio measurement of the secondary particles of the nickel-containing hydroxide. As shown from the above, the secondary particles of the nickel-containing hydroxide of the present disclosure have a uniform aspect ratio.

In the frequency distribution in the aspect ratio measurement of the secondary particles of the nickel-containing hydroxide of the present disclosure, the maximum peak value of the frequency is 4.60% or more, so that the nickel-containing hydroxide excellent in yield as a product can be obtained. Therefore, the nickel-containing hydroxide of the present disclosure is improved in productivity.

For the nickel-containing hydroxide of the present disclosure, the maximum peak value of the frequency is not particularly limited as long as it is 4.60% or more, and the lower limit value of the maximum peak value of the frequency is preferably 4.70% or more, more preferably 4.80% or more, and particularly preferably 4.90% or more, from the viewpoint of further improving the yield of the nickel-containing hydroxide obtained as a product. On the other hand, the upper limit value of the maximum peak value of the frequency is preferably 7.00% or less, and more preferably 6.50% or less, from the viewpoint of reduction in thermal conductivity during calcination caused by the improvement in filling properties when producing the positive electrode active material. The above-described lower limit value and upper limit value can be any combination thereof. The maximum peak value of the frequency is preferably 4.60% or more and 7.00% or less, more preferably 4.70% or more and 7.00% or less, even more preferably 4.80% or more and 6.50% or less, and particularly preferably 4.90% or more and 6.50% or less.

For the nickel-containing hydroxide of the present disclosure, the aspect ratio at the maximum peak value of the frequency is not particularly limited, and the lower limit value of the aspect ratio at the maximum peak value of the frequency is preferably 0.85% or more and more preferably 0.87% or more, from the viewpoint of further improving the yield of the nickel-containing hydroxide obtained as a product caused by further improving average circularity of the nickel-containing hydroxide powder. On the other hand, the upper limit value of the aspect ratio at the maximum peak value of the frequency is preferably 0.96% or less, and more preferably 0.94% or less, from the viewpoint of reduction in thermal conductivity during calcination caused by the improvement in filling properties when producing the positive electrode active material. The above-described upper limit value and lower limit value can be any combination thereof. The aspect ratio at the maximum peak value of the frequency is preferably 0.85 or more and 0.96 or less, and more preferably 0.87 or more and 0.94 or less.

It is preferable that the composition of the nickel-containing hydroxide of the present disclosure is presented by the following formula (A).

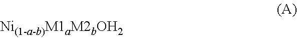

wherein 0<a≤0.8, 0≤b≤0.2, and 0<1−a−b; M1 is one or more additive elements selected from the group consisting of Co, Mn and Al; and M2 is one or more additive elements selected from the group consisting of Ca, Ti, V, Cr, Zr, Nb, Mo, B and W. More specific examples of the nickel-containing hydroxide of the present disclosure include a hydroxide containing nickel (Ni), one or more additive elements M1 selected from the group consisting of cobalt (Co), manganese (Mn) and aluminum (AI), and one or more additive elements M2 selected from the group consisting of calcium (Ca), titanium (Ti), vanadium (V), chromium (Cr), zirconium (Zr), niobium (Nb), molybdenum (Mo), boron (B) and tungsten (W).

From the viewpoint that a positive electrode active material having a high rate of utilization and excellent charge-discharge characteristics can be obtained, the lower limit value of a is preferably 0.01 or more, and more preferably 0.02 or more. The upper limit value of a is preferably 0.7 or less, and more preferably 0.5 or less. The above-described lower limit value and upper limit value can be any combination thereof. a is preferably 0.01 or more and 0.7 or less, and more preferably 0.02 or more and 0.5 or less.

From the viewpoint that a positive electrode active material having good cycle characteristics can be obtained, the upper limit value of b is preferably 0.1 or less, and more preferably 0.05 or less. The above-described upper limit value and lower limit value can be any combination thereof. b is preferably 0 or more and 0.1 or less, and more preferably 0 or more and 0.05 or less.

The particle size of the nickel-containing hydroxide of the present disclosure is not particularly limited, and for example, the lower limit value of the particle size at a cumulative volume percentage of 50% by volume (hereinafter, sometimes simply referred to as “D50”) is preferably 2.0 μm or more, and more preferably 4.0 μm or more, even more preferably 6.0 μm or more, and particularly preferably 8.0 μm or more, from the viewpoint of improving the filling density of the positive electrode active material. On the other hand, the upper limit value of D50 is preferably 20.0 μm or less, more preferably 19.0 μm or less, even more preferably 18.0 μm or less, and particularly preferably 16.0 μm or less, from the viewpoint of improving the contact with the non-aqueous electrolyte. The above-described lower limit value and upper limit value can be any combination thereof. D50 is preferably 2.0 μm or more and 20.0 μm or less, more preferably 4.0 μm or more and 19.0 μm or less, even more preferably 6.0 μm or more and 18.0 μm or less, and particularly preferably 8.0 μm or more and 16.0 μm or less.

The lower limit value of the particle size at a cumulative volume percentage of 90% by volume (hereinafter, sometimes simply referred to as “D90”) of the nickel-containing hydroxide of the present disclosure is preferably 10.0 μm or more, and more preferably 15.0 μm or more, from the viewpoint of improving the filling density of the positive electrode active material. On the other hand, the upper limit value of D90 is preferably 40.0 μm or less, and more preferably 35.0 μm or less, from the viewpoint of improving the contact with the non-aqueous electrolyte. The above-described lower limit value and upper limit value can be any combination thereof. D90 is preferably 10.0 μm or more and 40.0 μm or less, and more preferably 15.0 μm or more and 35.0 μm or less.

The lower limit value of the particle size at a cumulative volume percentage of 10% by volume (hereinafter, sometimes simply referred to as “D10”) of the nickel-containing hydroxide of the present disclosure is preferably 1.0 μm or more, and more preferably 2.0 μm or more, from the viewpoint of improving the filling density of the positive electrode active material. On the other hand, the upper limit value of D10 is preferably 10.0 μm or less, and more preferably 8.0 μm or less, from the viewpoint of improving the contact with the non-aqueous electrolyte. The above-described lower limit value and upper limit value can be any combination thereof. D10 is preferably 1.0 μm or more and 10.0 μm or less, and more preferably 2.0 μm or more and 8.0 μm or less. D10, D50 and D90 refer to particle sizes measured with a particle size distribution measuring device using a laser diffraction and scattering method.

The particle size distribution width of the nickel-containing hydroxide of the present disclosure is not particularly limited and can be appropriately selected depending on the conditions of use for the positive electrode active material or the like. For example, the lower limit value of (D90−D10)/D50 is preferably 0.50 or more, more preferably 0.60 or more, and particularly preferably 0.70 or more, from the viewpoint of improving the filling density of the positive electrode active material. On the other hand, the upper limit value of (D90−D10)/D50 is preferably 1.20 or less, more preferably 1.10 or less, and particularly preferably 1.00 or less regardless of the particle size of the nickel-containing hydroxide, from the viewpoint of making the various properties of the positive electrode active material uniform. The above-described lower limit value and upper limit value can be any combination thereof. (D90−D10)/D50 is preferably 0.50 or more and 1.20 or less, more preferably 0.60 or more and 1.10 or less, and particularly preferably 0.70 or more and 1.00 or less.

Thereafter, the method for producing a nickel-containing hydroxide of the present disclosure will be described. First, by utilizing a coprecipitation method, a solution containing metal salts (hereinafter, sometimes simply referred to as “solution of metal salts”), for example, a solution containing a nickel salt (such as a sulfate), a cobalt salt (such as a sulfate) and a salt of an additive element (such as a sulfate), as well as a complexing agent and a pH adjuster are added appropriately for neutralization reaction in a reaction vessel to prepare a nickel-containing hydroxide, thereby obtaining a slurry suspension containing the nickel-containing hydroxide. For example, water is used as a solvent for the suspension. An inert gas, such as nitrogen gas, or air or the like is fed to the reaction vessel to carry out the neutralization reaction in an inert gas atmosphere or under an air atmosphere.

The complexing agent can form a complex with an ion of a metal element such as a nickel ion, a cobalt ion, and an ion of an additive element, in an aqueous solution, and examples thereof include an ammonium ion donor. Examples of the ammonium ion donor include ammonia water, ammonium sulfate, ammonium chloride, ammonium carbonate and ammonium fluoride. Examples of the pH adjuster for adjusting the pH value of the aqueous solution during the neutralization reaction include an alkali metal hydroxide. Examples of the alkali metal hydroxide include sodium hydroxide and potassium hydroxide.

The above-described solution of metal salts, pH adjuster and complexing agent are continuously fed to the reaction vessel appropriately and the materials in the reaction vessel are appropriately stirred for a coprecipitation reaction of the metals in the solution of metal salts (for example, nickel, cobalt and an additive element) to prepare a nickel-containing hydroxide. During the coprecipitation reaction, the temperature of the reaction vessel is controlled, for example, to 10° C. or more and 80° C. or less, and preferably to 20° C. or more and 70° C. or less. The pH based on a liquid temperature of 40° C. is controlled, for example, to 10.0 or more and 13.5 or less, and preferably 10.2 or more and 13.0 or less. When the ammonium ion donor is fed to the reaction vessel to cause a coprecipitation reaction, the maximum peak value of the frequency in the frequency distribution in the aspect ratio measurement of secondary particles of the nickel-containing hydroxide can be adjusted to 4.60% or more by controlling the ammonia percentage (mol %) in the gas phase region in the reaction vessel within a predetermined range.

The ammonia percentage in the gas phase region in the reaction vessel can be determined by the following calculation equations. Here, the determination of the ammonia percentage will be described, as an example, about the case where ammonium sulfate is used as the ammonium ion donor.

$$Ammonia volatilization rate ( \% ) = 100 - ( measured concentration of ammonia in the solution in reaction vessel ( g / L ) / theoretical concentration of ammonia in the solution in reaction vessel ( g / L ) ) \times 100$$

$$Ammonia flow rate ( g / min ) = flow rate of aqueous ammonium sulfate solution ( L / min ) \times concentration of ammonia sulfate ( g / L ) \times ( 17 / 132 ) \times 2$$

$$Ammonia gas flow rate in gas phase region ( L / min ) = ammonia flow rate ( g / min ) \times ( 22.4 ( L / mol ) / 17 ( g / mol ) ) \times ( ammonia volatilization rate ( \% ) / 100 )$$

$$Ammonia percentage in gas phase region ( mol \% ) = ( ammonia gas flow rate in gas phase region ( L / min ) / ( ammonia gas flow rate in gas phase region ( L / min ) + gas flow rate of gases without ammonia in gas phase region ( L / min ) ) ) \times 100$$

The measured concentration of ammonia in the solution in the reaction vessel can be determined by subjecting a slurry suspension containing the nickel-containing hydroxide to neutralization titration by adding hydrochloric acid or an aqueous sodium hydroxide solution to the slurry suspension. When hydrochloric acid is added to the slurry suspension containing the nickel-containing hydroxide, ammonium chloride is produced. When formaldehyde is added to this ammonium chloride, hexamethylenetetramine, which is not involved in the titration, and a free acid are produced. This free acid is titrated with an aqueous sodium hydroxide solution to calculate the ammonia concentration. As a titration device, for example, a COM-A19 (manufactured by HIRANUMA Co., Ltd.) can be used.

The measured concentration of ammonia in the solution in the reaction vessel is preferably a value measured when the concentration of ammonia has been stabilized within a variation of 10%, and the ammonia percentage (mol %) in the gas phase region in the reaction vessel is more preferably a value calculated from the concentration of ammonia in the reaction vessel when the concentration of ammonia (g/L) has been stabilized within a variation of 10%.

The ammonia percentage (mol %) in the gas phase region in the reaction vessel may need to be adjusted depending on the composition of the nickel-containing hydroxide, and is, for example, preferably 1.0 mol % or more and 8.0 mol % or less, more preferably 1.2 mol % or more and 7.0 mol % or less, and particularly preferably 1.3 mol % or more and 6.0 mol % or less.

Examples of the reaction vessel to be used in the method for producing a nickel-containing hydroxide of the present disclosure include a continuous type reaction vessel in which the resulting nickel-containing hydroxide is overflowed to separate it, or a batch type reaction vessel in which the nickel-containing hydroxide is not discharged from the system until the reaction is completed. The method using the continuous type reaction vessel may have a slurry withdrawal step in which a slurry containing the nickel-containing hydroxide that has been overflowed from the reaction vessel is fed to a storage vessel and continuously withdrawn from the storage vessel; a classification step in which the slurry containing the nickel-containing hydroxide is continuously fed to a classifier to classify a first particle portion and a second particle portion having an average particle size smaller than that of the first particle portion; a first particle portion-returning step in which the first particle obtained in the classification step is continuously fed to the storage vessel; and a second particle portion-returning step in which the second particle portion obtained in the classification step is continuously returned to the reaction vessel, and in this method, the nickel-containing hydroxide that has overflowed from the storage vessel may be one of the object of the present disclosure.

The suspension of the nickel-containing hydroxide obtained in the neutralization reaction process as described above is filtered and then the resultant is washed with an aqueous alkali solution to remove impurities contained in the nickel-containing hydroxide. Then, solid-liquid separation is carried out, and if necessary, the solid phase containing the nickel-containing hydroxide is washed with water, heat-treated and dried to obtain the nickel-containing hydroxide as a product.

Thereafter, the positive electrode active material for the non-aqueous electrolyte secondary battery with the nickel-containing hydroxide of the present disclosure as a precursor (hereinafter, sometimes simply referred to as the “positive electrode active material of the present disclosure”) will be described. The positive electrode active material of the present disclosure is an aspect in which the nickel-containing hydroxide of the present disclosure as a precursor is calcined with, for example, a lithium compound. The crystal structure of the positive electrode active material of the present disclosure is a layered structure, and is more preferably a hexagonal crystal structure or a monoclinic crystal structure, from the viewpoint of obtaining a secondary battery having a high discharge capacity. The positive electrode active material of the present disclosure can be used, for example, as a positive electrode active material for a lithium-ion secondary battery. When producing the positive electrode active material of the present disclosure, a step of converting the nickel-containing hydroxide into a nickel-containing oxide may be carried out in advance. Examples of the method for converting the nickel-containing hydroxide into a nickel-containing oxide include an oxidation treatment in which the nickel-containing hydroxide is calcined at a temperature of 300° C. or more and 800° C. or less under an atmosphere containing an oxygen gas for 1 hour or more and 10 hours or less.

Thereafter, the method for producing a positive electrode active material of the present disclosure will be described. For example, in the method for producing a positive electrode active material of the present disclosure, a lithium compound is first added to the nickel-containing hydroxide of the present disclosure or a nickel-containing oxide to prepare a mixture of the nickel-containing hydroxide or nickel-containing oxide and the lithium compound. The lithium compound is not particularly limited as long as it is a compound having lithium, and examples thereof can include lithium carbonate and lithium hydroxide.

Thereafter, the obtained mixture can be calcined to produce a positive electrode active material. Examples of the calcination conditions include a calcination temperature of 700° C. or more and 1000° C. or less, a rate of temperature increase of 50° C./h or more and 300° C./h or less, and a calcination time of 5 hours or more and 20 hours or less. The calcination atmosphere is not particularly limited, and examples thereof include air or oxygen. The calcination furnace to be used for calcination is not particularly limited, and examples thereof include a stationary box furnace and a roller hearth continuous furnace.

### EXAMPLES

Thereafter, examples of the nickel-containing hydroxide of the present disclosure will be described, but the present disclosure is not limited to these examples as long as examples do not depart from the spirit of the present disclosure.

### Production of Nickel-Containing Hydroxide in Examples and Comparative Examples

### Example 1

Into a reaction vessel were continuously dropped an aqueous solution having nickel sulfate and cobalt sulfate and manganese sulfate dissolved at a predetermined ratio (the moles of nickel:the moles of cobalt:the moles of manganese=90:5:5), an aqueous ammonium sulfate solution as a complexing agent, and an aqueous sodium hydroxide solution. The mixed solution in the reaction vessel was continuously stirred with a stirrer while maintaining the pH at 11.2 based on a liquid temperature of 40° C. and the ammonia percentage in the gas phase region in the reaction vessel at 2.9 mol %. The liquid temperature of the mixed solution in the reaction vessel was maintained at 70° C. The nickel-containing hydroxide produced by the neutralization reaction was allowed to overflow from an overflow pipe of the reaction vessel into a storage vessel, and was continuously withdrawn from the storage vessel as a slurry of the nickel-containing hydroxide. The withdrawn slurry of the nickel-containing hydroxide was press fitted into a liquid cyclone classifier (type “T10-b”, manufactured by Murata Kogyo Co., Ltd.) at a flow rate of 5.0 L/min of the slurry of the nickel-containing hydroxide, and classified into a first particle portion and a second particle portion having an average particle size smaller than that of the first particle portion. The first particle portion obtained in the classification step was continuously fed to the storage vessel, and the second particle portion was continuously returned to the reaction vessel. The slurry of the nickel-containing hydroxide that had overflowed from the storage vessel was removed as a suspension. The removed suspension of the nickel-containing hydroxide was filtered and then washed with an aqueous alkali solution for solid-liquid separation. The separated solid phase was then washed with water, and further subjected to each of dehydration and drying treatments to obtain the nickel-containing hydroxide of Example 1.

### Example 2

Into a reaction vessel were continuously dropped an aqueous solution having nickel sulfate and cobalt sulfate and manganese sulfate dissolved at a predetermined ratio (the moles of nickel:the moles of cobalt:the moles of manganese=90:5:5), an aqueous ammonium sulfate solution as a complexing agent, and an aqueous sodium hydroxide solution. The mixed solution in the reaction vessel was continuously stirred with a stirrer while maintaining the pH at 10.9 based on a liquid temperature of 40° C. and the ammonia percentage in the gas phase region in the reaction vessel at 1.4 mol %. The liquid temperature of the mixed solution in the reaction vessel was maintained at 70° C. The nickel-containing hydroxide produced by the neutralization reaction was allowed to overflow from an overflow pipe of the reaction vessel, and was removed as a suspension. The removed suspension of the nickel-containing hydroxide was filtered and then washed with an aqueous alkali solution for solid-liquid separation. The separated solid phase was then washed with water, and further subjected to each of dehydration and drying treatments to obtain the nickel-containing hydroxide of Example 2.

### Example 3

Into a reaction vessel were continuously dropped an aqueous solution having nickel sulfate and cobalt sulfate and manganese sulfate dissolved at a predetermined ratio (the moles of nickel:the moles of cobalt:the moles of manganese=60:20:20), an aqueous ammonium sulfate solution as a complexing agent, and an aqueous sodium hydroxide solution. The mixed solution in the reaction vessel was continuously stirred with a stirrer while maintaining the pH at 11.9 based on a liquid temperature of 40° C. and the ammonia percentage in the gas phase region in the reaction vessel at 3.6 mol %. The nickel-containing hydroxide of Example 3 was obtained in a similar manner to Example 2, except that the liquid temperature of the mixed solution in the reaction vessel was maintained at 60° C.

### Example 4

Into a reaction vessel were continuously dropped an aqueous solution having nickel sulfate and cobalt sulfate and aluminum sulfate dissolved at a predetermined ratio (the moles of nickel:the moles of manganese:the moles of aluminum=90:9.5:0.5), an aqueous ammonium sulfate solution as a complexing agent, and an aqueous sodium hydroxide solution. The mixed solution in the reaction vessel was continuously stirred with a stirrer while maintaining the pH at 11.1 based on a liquid temperature of 40° C. and the ammonia percentage in the gas phase region in the reaction vessel at 1.4 mol %. The nickel-containing hydroxide of Example 4 was obtained in a similar manner to Example 2, except that the liquid temperature of the mixed solution in the reaction vessel was maintained at 70° C.

### Comparative Example 1

Into a reaction vessel were continuously dropped an aqueous solution having nickel sulfate and cobalt sulfate and manganese sulfate dissolved at a predetermined ratio (the moles of nickel:the moles of cobalt:the moles of manganese=90:5:5), an aqueous ammonium sulfate solution as a complexing agent, and an aqueous sodium hydroxide solution. The mixed solution in the reaction vessel was continuously stirred with a stirrer while maintaining the pH at 10.9 based on a liquid temperature of 40° C. and the ammonia percentage in the gas phase region in the reaction vessel at 0.1 mol %. The nickel-containing hydroxide of Comparative Example 1 was obtained in a similar manner to Example 2, except that the liquid temperature of the mixed solution in the reaction vessel was maintained at 70° C.

### Comparative Example 2

Into a reaction vessel were continuously dropped an aqueous solution having nickel sulfate and manganese sulfate dissolved at a predetermined ratio (the moles of nickel:the moles of manganese=80:20), and an aqueous sodium hydroxide solution. The mixed solution in the reaction vessel was continuously stirred with a stirrer while maintaining the pH at 10.4 based on a liquid temperature of 40° C. and the ammonia percentage in the gas phase region in the reaction vessel at 0 mol %. The nickel-containing hydroxide of Comparative Example 2 was obtained in a similar manner to Example 2, except that the liquid temperature of the mixed solution in the reaction vessel was maintained at 50° C.

### Comparative Example 3

Into a reaction vessel were continuously dropped an aqueous solution having nickel sulfate and cobalt sulfate and aluminum sulfate dissolved at a predetermined ratio (the moles of nickel:the moles of cobalt:the moles of aluminum=93:4:3), an aqueous ammonium sulfate solution as a complexing agent, and an aqueous sodium hydroxide solution. The mixed solution in the reaction vessel was continuously stirred with a stirrer while maintaining the pH at 11.2 based on a liquid temperature of 40° C. and the ammonia percentage in the gas phase region in the reaction vessel at 9.8 mol %. The nickel-containing hydroxide of Comparative Example 3 was obtained in a similar manner to Example 2, except that the liquid temperature of the mixed solution in the reaction vessel was maintained at 50° C.

The evaluation items for the physical properties of the nickel-containing hydroxide in Examples and Comparative Examples are as follows.

### (1) Composition Analysis of Nickel-Containing Hydroxide

The composition analysis was carried out with an inductively-coupled plasma emission spectrometer (Optima 8300, manufactured by PerkinElmer Japan Co., Ltd.) after dissolving the obtained nickel-containing hydroxide in hydrochloric acid.

### (2) Maximum Peak Value of Frequency, and Aspect Ratio at Maximum Peak Value of Frequency

The maximum peak value of the frequency and the aspect ratio at the maximum peak value of the frequency were obtained by creating a map of frequency distribution in the aspect ratio measurement as follows.

Each of 10,000 nickel-containing hydroxide particles was subjected to measurement of the aspect ratio with an automated static image analyzer (Morphologi 4, Malvern Panalytical Ltd.), and a graph was created showing the aspect ratio of the nickel-containing hydroxide on the abscissa axis (x-axis) and the frequency of the aspect ratio on the ordinate axis (y-axis). Specifically, the nickel-containing hydroxide was introduced into the feed section of the automated static image analyzer, sprayed onto a prepared slide and fixed thereon, and the fixed nickel-containing hydroxide was observed under an optical microscope to acquire an image. The acquired image was analyzed and the aspect ratio was calculated for each of the 10,000 nickel-containing hydroxide particles.

The measurement conditions for the automated static image analyzer were as follows:
Magnification: ×50 (0.5 μm to 50 μm)
Filtering: No measurement was carried out for the envelope degree of 0.95 or less.

### (3) D10, D50 and D90

Each of D10, D50, and D90 was measured with a particle size distribution measuring device (LA-960, manufactured by Horiba, Ltd.) (principle: laser diffraction and scattering method). For the measurement conditions, water was used as a solvent, 1 mL of sodium hexametaphosphate was introduced as a dispersant so that the transmittance after introducing a sample was in the range of 85±3%, and ultrasonic waves were generated to disperse the sample. The refractive index of water of 1.333 was used as the refractive index of the solvent during the analysis.

### (4) Passage Through Sieve

A 20φ 325 mesh sieve was fitted with an ultrasonic oscillator (“PNS35-50-S”, manufactured by Artech; maximum output: 30 W), 500 g of the obtained nickel-containing hydroxide was placed on the sieve, and the ultrasonic oscillator was turned on. Twenty seconds after turning on the ultrasonic oscillator, it was stopped. Thereafter, the nickel-containing hydroxide that had passed through the sieve after 20 seconds was weighed, and the passage through a sieve, that is, the yield, was determined using the following equation.

$$Yield ( \% ) = [ amount of nickel - containing hydroxide that passed through sieve ( g ) / 500 ( g ) ] \times 100$$

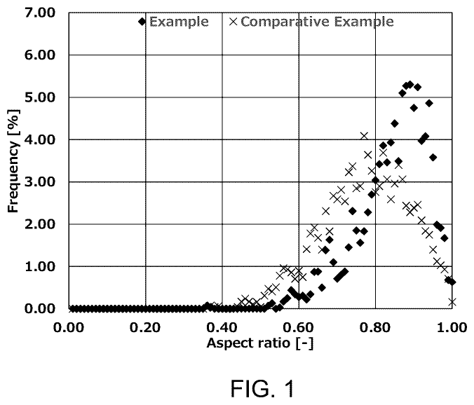

The evaluation results are shown in Table 1 below. The map of frequency distribution in the aspect ratio measurement for Example 1 and Comparative Example 3 is shown in FIG. 1.

TABLE 1

| | | Ammonia | Aspect | | | |
|---|---|---|---|---|---|---|
| | | percentage | ratio at | | | |
| | | in gas phase | maximum | Maximum | | |
| | | region in | peak | peak | | Passage |
| | | reaction | value of | value of | | through |
| | Composition | vessel | frequency | frequency | D50 | sieve |
| | (mole ratio) | (mol %) | [—] | [%] | [μm] | [% by mass] |
| Example 1 | Ni/Co/Mn = 90/5/5 | 2.9 | 0.89 | 5.30 | 12 | 100 |
| Example 2 | Ni/Co/Mn = 90/5/5 | 1.4 | 0.89 | 5.61 | 12 | 84 |
| Example 3 | Ni/Co/Mn = 60/20/20 | 3.6 | 0.88 | 4.76 | 3 | 48 |
| Example 4 | Ni/Mn/Al = 90/9.5/0.5 | 1.4 | 0.88 | 5.05 | 12 | 100 |
| Comparative Example 1 | Ni/Co/Mn = 90/5/5 | 0.1 | 0.82 | 4.50 | 9 | 9 |
| Comparative Example 2 | Ni/Mn = 80/20 | 0 | 0.84 | 3.64 | 5 | 1 |
| Comparative Example 3 | Ni/Co/Al = 93/4/3 | 9.8 | 0.77 | 4.09 | 13 | 7 |

As shown in Table 1 above, the nickel-containing hydroxide of each of Examples 1 to 4, which had a maximum peak value of frequency of 4.60% or more, had an excellent passage through a sieve, that is, an excellent yield. Therefore, it was found that the capacity of the nickel-containing hydroxide production line was improved for each of Examples 1 to 4.

For the nickel-containing hydroxide of Examples 1 to 4, which had a maximum peak value of the frequency of 4.60% or more, the ammonia percentage in the gas phase region in the reaction vessel was maintained at 1.4 to 3.6 mol %.

On the other hand, as shown in Table 1 above, the nickel-containing hydroxide of Comparative Examples 1 to 3, which had a maximum peak value of the frequency of less than 4.60%, did not provide any excellent passage through a sieve and had a poor yield.

For the nickel-containing hydroxide of Comparative Examples 1 to 3, which had a maximum peak value of the frequency of less than 4.60%, the ammonia percentage in the gas phase region in the reaction vessel was maintained at 0.1 mol %, 0 mol %, and 9.8 mol %, respectively.

The nickel-containing hydroxide of an embodiment of the present disclosure can be used as a precursor of a positive electrode active material which can produce a positive electrode active material excellent in the yield of the nickel-containing hydroxide obtained as a product, and can therefore be used in a wide range of fields, such as portable devices and vehicles.

What is claimed is:

1. A nickel-containing hydroxide which is a precursor of a positive electrode active material of a non-aqueous electrolyte secondary battery, wherein in a frequency distribution in an aspect ratio measurement of secondary particles of the nickel-containing hydroxide, a maximum peak value of a frequency is 4.60% or more.

2. The nickel-containing hydroxide according to claim 1, wherein an aspect ratio at the maximum peak value of the frequency is 0.85 or more.

3. The nickel-containing hydroxide according to claim 1, wherein an aspect ratio at the maximum peak value of the frequency is 0.85 or more and 0.96 or less.

4. The nickel-containing hydroxide according to claim 1, represented by the following formula (A): 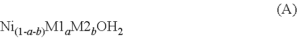
wherein 0<a≤0.8, 0≤b≤0.2, and 0<1−a−b; M1 is one or more additive elements selected from the group consisting of Co, Mn and Al; and M2 is one or more additive elements selected from the group consisting of Ca, Ti, V, Cr, Zr, Nb, Mo, B and W.

5. The nickel-containing hydroxide according to claim 1, wherein a particle size (D50) of the secondary particles of the nickel-containing hydroxide at a cumulative volume percentage of 50% by volume is 2.0 μm or more and 20.0 μm or less.

6. The nickel-containing hydroxide according to claim 1, wherein the non-aqueous electrolyte secondary battery is a lithium-ion secondary battery.

7. A positive electrode active material of a non-aqueous electrolyte secondary battery, wherein the nickel-containing hydroxide according to claim 1 is calcined with a lithium compound.
